(19) United States
(12) Patent Application Publication
(10) Pub. No.: US 2026/0293877 A1
(43) Pub. Date: Oct. 1, 2026

(54) DISPERSION DEVICE WITH RATE ADJUSTMENT MECHANISM

(71) Applicant: Chandler Bennett, Salinas, CA (US)

(72) Inventor: Chandler Bennett, Salinas, CA (US)

(21) Appl. No.: 19/576,330

(22) Filed: Mar. 24, 2026

Related U.S. Application Data
(60) Provisional application No. 63/777,195, filed on Mar. 25, 2025.
(60) Provisional application No. 63/824,468, filed on Jun. 16, 2025.

(51) Int. Cl. A01M 9/00

(52) U.S. Cl. CPC A01M 9/0061; A01M 9/0069; A01M 9/0076

(57) ABSTRACT

An improved device for dispersing materials over a target area is disclosed. The device includes a rate adjustment mechanism configured to modify the dispersion rate during operation. Materials are contained in a rotatable container having a series of openings in its outer shell. The rate at which materials are released from the container is determined by the positioning of a sleeve wrapped around the container which has a series of openings corresponding to the container openings. The position of the sleeve is, in turn, controlled by a mechanism configured to engage with the sleeve and move it relative to the container.

### PRIORITY CLAIM

This non-provisional application claims priority to Provisional Patent Application Ser. No. 63/777,195, entitled “Dispersion Device with Rate Adjustment Mechanism,” filed on Mar. 25, 2025 and Provisional Patent Application Ser. No. 63/824,468, entitled “Dispersion Device with Rate Adjustment Mechanism,” filed on Jun. 16, 2025; all of which are included by reference as fully set forth herein.

### RELATIONSHIP TO PRIOR APPLICATIONS

This application relates to improvements to the apparatus, system, and methods disclosed in U.S. Utility patent application Ser. No. 18/476,721, entitled “Method and Apparatus used for Biological Control of Agricultural Pests,” filed Sep. 28, 2023. The subject matter disclosed herein also relates to international application PCT/US24/41451, entitled “Method and System for Controlling Application Rate of Biological Agents.” These prior applications are included by reference as fully set forth herein.

### TECHNICAL FIELD

The present invention relates generally to the field of application of materials over a target area, particularly application of biological agents, such as biological organisms or materials used to control agricultural pests.

### SUMMARY OF THE INVENTION

The present invention is directed to an apparatus and method for dispersing materials over a target area, such as application of pest-control agents over agricultural fields. A particular object of the present invention is to provide a dispersion device comprising a means of modifying the dispersion rate during operation, such as an airborne drone-mounted device comprising a mechanism for mid-flight adjustment of the payload release rate.

In various embodiments, an apparatus according to the present invention comprises a rotatable container having a hollow inner cavity surrounded by an outer shell with a first set of openings (referred to herein as the “container openings”) and a sleeve arranged around the shell of the container and having a second set of openings (referred to herein as the “sleeve openings”). The apparatus may further comprise a sleeve adjustment mechanism coupled to the sleeve and configured to slide the sleeve forwards or backwards along the length of the container.

During operation, the container is rotated, urging materials in the container's inner cavity through the openings in the container's outer shell and/or sleeve. By moving the sleeve relative to the container, the alignment of the sleeve openings and the container openings may be adjusted, thereby widening, narrowing, or closing the space through which materials may pass.

Among other uses, the present invention may be employed to spread biological agents over agricultural areas. For example, in certain embodiments, the apparatus described above may be mounted to an unmanned aerial vehicle (UAV), wherein the container is suspended from a mounting frame assembly coupled to the ends of the container by rotational couplings and the sleeve adjustment mechanism is disposed between the mounting frame and the sleeve. The sleeve adjustment mechanism may be connected to an onboard computer, allowing it to be activated by a user in communication with the computer or based on commands executed by software running on the computer.

### BRIEF DESCRIPTION OF THE DRAWINGS

FIG. 1 is a perspective view of an embodiment of a device according to the present invention.

FIG. 2 is an alternative perspective view of the device of FIG. 1.

FIG. 3 is an alternative perspective view of the device of FIG. 1.

FIG. 4 is an alternative perspective view of the device of FIG. 1.

FIG. 5 is a front view of the device of FIG. 1.

FIG. 6 is a bottom view of the device of FIG. 1.

FIG. 7 is a side view of the device of FIG. 1.

FIG. 8 is a side view of the device of FIG. 1.

FIG. 9 is an exploded view of the device of FIG. 1.

### DETAILED DESCRIPTION

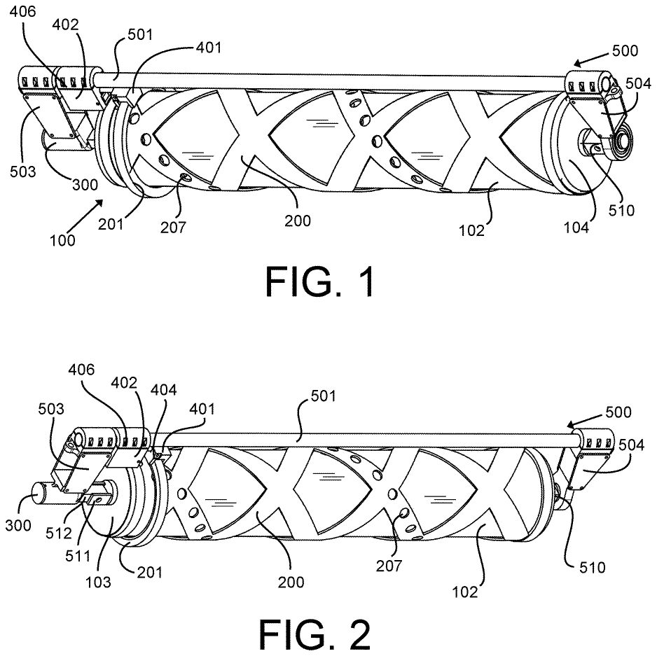

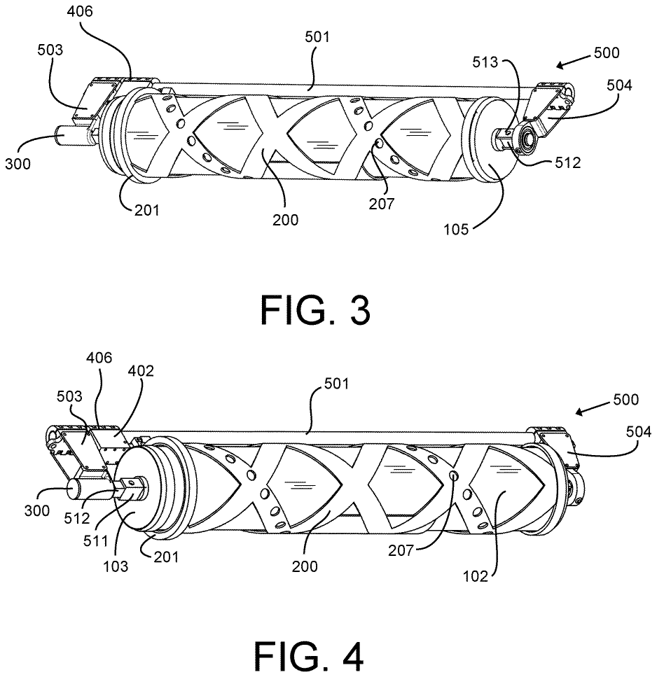

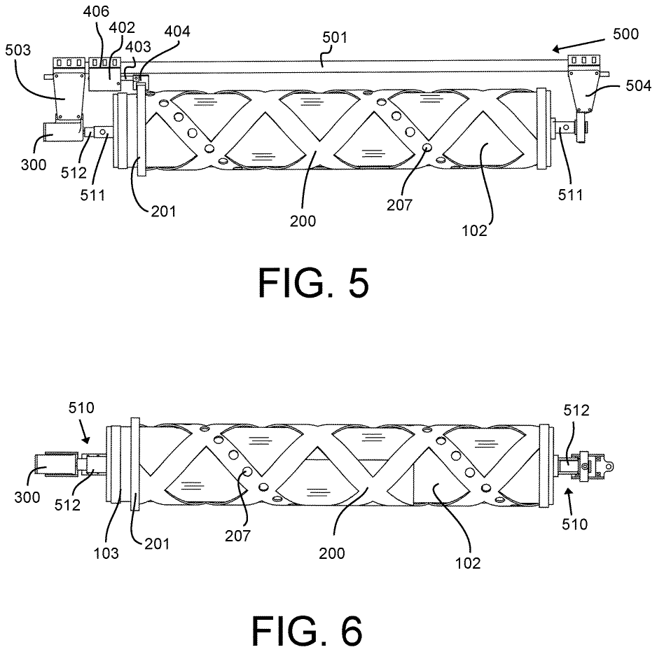

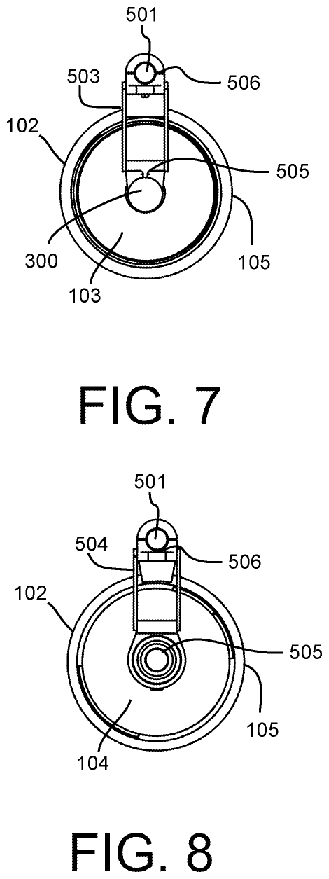

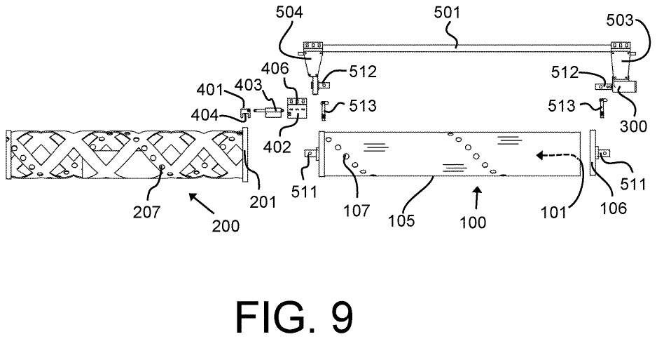

U.S. Utility patent application Ser. No. 18/476,721 discloses an apparatus for dispersing organisms or materials such as biological agents for controlling agricultural pests. FIGS. 1-9 illustrate an embodiment of this apparatus comprising a container 100 having an inner cavity 101 surrounded by a shell 102 (also referred to therein as an “outer wall”). For example, the container 100 may be a cylindrical drum, wherein the outer shell 102 comprises a first end wall 103 and second end wall 104 (also referred to in prior applications as the drum's first and second “base”), these two ends being separated by a cylindrical side wall 105. In some embodiments, the first or second end wall may be a removable cap 106, allowing materials 900 to be loaded into the inner cavity 101.

The container shell 102 has a first plurality of openings 107 (referred to herein as the “container openings”) through which the materials 900 are released. In various embodiments, the apparatus further comprises a sleeve 200 having a second plurality of openings 207 (referred to herein as the “sleeve openings”), disposed proximate to the container shell 102, preferably such that the inner surface of the sleeve 200 is substantially in contact with the outer surface of the shell 102. For example, the sleeve may wrap around the side wall 105 of the cylindrical drum 100. The position of the sleeve 200 relative to the container shell 102 is adjustable, such that the container openings 107 and the sleeve openings may 207 be aligned, partially aligned, or unaligned. For example, the sleeve 200 may be configured to slide axially around the side wall 105 of the cylindrical drum or may be configured to slide back and forth along the length of the side wall 105.

In operation, materials 900 are dispersed by rotating the container, which urges the materials towards the container openings 107 by means of centrifugal force, gravity, the tumbling motion of the materials, and/or a combination of these forces. For example, the cylindrical drum container 100 may be oriented horizontally, such that its side wall 105 is substantially parallel to the ground, while its first end wall 103 or second end wall 104 is coupled to a motor 300 that rotates the container about its central axis. The rate at which materials are released from the container (also referred to as the “application rate” or “dispersion rate”) may be controlled in part by adjusting the position of the sleeve 200 relative to the container shell 102, thereby adjusting the degree of alignment between the container openings 107 and the sleeve openings 207. When the container openings 107 and sleeve openings 207 are fully unaligned, materials 900 are obstructed from passing out of the container's inner cavity 101. When fully or partially aligned, the container openings and sleeve openings form gaps 108 through which the materials may pass. The size and shape of the gaps 108 may be controlled by adjusting the position of the sleeve 200 relative to the container shell 102.

The present application is directed to an improvement on the apparatus described above, wherein a sleeve adjustment mechanism 400 is provided, as illustrated in FIGS. 1-9. This sleeve adjustment mechanism 400 is configured to move, by mechanical means, the position of the sleeve 200 relative to the container shell 102. In various embodiments, the sleeve adjustment mechanism 400 may comprise a first end 401 that engages with the sleeve 200 and a second end 402 coupled to a mounting frame 500 or other support structure. A mechanical element 403 is disposed between the first end 401 and second end 402 of the sleeve adjustment mechanism 400 and configured to move the first end 401 relative to the second end 402. For example, the mechanical element may be a linear actuator that extends or retracts upon activation.

The sleeve may comprise a structure designed to better engage with the sleeve adjustment mechanism. For example, this mechanism engagement structure may be a flange 201 extending axially outward from the outer surface of the sleeve 200, forming a ring around the cylindrical circumference of the drum container 100. In this embodiment, the first end 401 of the sleeve adjustment mechanism may comprise a sleeve engagement assembly 404 configured to clasp or otherwise engage the sides of the mechanism engagement flange 201. The sleeve engagement assembly 404 may include bearings 405 that contact the flange 201, allowing the container 100 to rotate freely around its central axis while still controlling linear movement of the sleeve 200 along the length of the container. When the linear actuator 403 or other mechanical element is activated, the first end 401 of the sleeve adjustment mechanism 400 pushes or pulls the sleeve 200 along the length of the container side wall 105 via the mechanism engagement flange 201.

The container of the dispersion apparatus is coupled to a mounting frame assembly 500 or other support structure, which in turn may be mounted to a carrier vehicle, such as an unmanned aerial vehicle. The mounting frame assembly may comprise a first arm 503 to engage with the first end wall 103 of the container and/or a second arm 504 to engage with the second end wall 104. For example, the distal end 505 of a frame arm 503, 504 may engage a container wall 103, 104 via a rotational coupling 510, such as a journal bearing interface, disposed at the container's central axis. The rotational coupling 510 may comprise a first coupling element 511 fixed to the container wall 103, 104 and a second coupling element 512 fixed to the frame arm 503, 504, the two elements being coupled by a suitable fastening means 513, such as a bolt. The container may be rotated within the frame arms by a motor 300, which may be housed on or within the first arm 503 and may engage with the first end wall of the container via the motor's rotational drive mechanism.

The proximal ends 506 of the frame arms 503, 504 may be coupled to a lateral boom 501, such that the container 100 is suspended from the boom 501. The second end 402 of the sleeve adjustment mechanism 400 may also be coupled to the boom 501 and may include a clamp 406 or other coupling element for that purpose. The second end 402 of the sleeve adjustment mechanism 400 thus remains fixed to the mounting frame 500, resulting in the first end 401 moving relative to the mounting frame 500 upon activation of the mechanical element 403.

Operation of the dispersion apparatus may be controlled by a computer, such as an on-board microcontroller. The computer may be connected to and configured to activate the sleeve adjustment mechanism. For example, the linear actuator 403 may be activated by receiving a pulse width modulation (PWM) signal from the microcontroller. The PWM relates to a known position for the linear actuator, which may be determined based on certain conditions and requirements output by software operating on the microcontroller or commands relayed by the microcontroller. The computer may also be connected to the motor 300 and configured to activate and control the speed of the motor and may further be connected to a user interface via wireless communication or similar means.

The sleeve adjustment mechanism 400 allows the application rate of the dispersion apparatus to be adjusted during operation, including mid-flight adjustments to the application rate of a UAV-mounted apparatus. For example, upon activation, the sleeve adjustment mechanism 400 may slide the sleeve 200 forward or back along the length of the side wall 105 of the container shell 102, thereby changing the size and/or shape of the gaps 108 formed by the container openings 107 and sleeve openings 207. Due to the engagement of the flange 201 and sleeve engagement assembly 404 via bearings 405, the container 100 and sleeve 200 may both continue to rotate as the sleeve 200 moves laterally.

The sleeve adjustment mechanism 400 may be activated manually by a user, transmitting commands via the microcontroller, or may be determined by software processes. For example, as disclosed in more detail in international application PCT/US24/41451, the apparatus may be configured to operate in “Rate Control” or “Variable Rate” modes, according to which the dispersion rate is increased or decreased by software algorithms to achieve either a target average dispersion rate over time or a pre-determined rate for a particular area. This can be accomplished by means of the sleeve adjustment mechanism 400, which opens or closes the gaps 108 through which materials pass according to commands from the microcontroller.

What is claimed is:

1. A dispersion apparatus, comprising:
A container having an inner cavity surrounded by a shell, wherein the shell comprises a plurality of container openings;
A sleeve disposed around the container and comprising a plurality of sleeve openings;
A mounting frame; and
A sleeve adjustment mechanism having a first end coupled to the sleeve and a second end coupled to the mounting frame.

2. The apparatus of claim 1, wherein the sleeve adjustment mechanism comprises a linear actuator.

3. The apparatus of claim 1, wherein the mounting frame is coupled to the container by at least one rotatable coupling.

4. The apparatus of claim 3, wherein the rotatable coupling comprises a bearing assembly.

5. The apparatus of claim 3, wherein the mounting frame comprises a boom and at least one arm disposed between the boom and the container, wherein the arm is coupled to the container by the rotatable coupling.

6. The apparatus of claim 4, further comprising a motor disposed within the arm of the mounting frame.

7. The apparatus of claim 1, wherein the sleeve adjustment mechanism is configured to adjust the position of the sleeve relative to the container and wherein the position of the sleeve determines the alignment of the sleeve openings relative to the container openings.

8. The apparatus of claim 7, wherein the container has a first end and a second end, separated by a length and wherein the sleeve adjustment mechanism is configured to move the sleeve along the length of the container.

9. A method for dispersing materials comprising the following steps:
storing the materials within a container having an inner cavity, a shell, and a movable sleeve, wherein the shell comprises a plurality of container openings and the sleeve comprises a plurality of sleeve openings;
moving the sleeve to a first position relative to the container shell, wherein the first position of the sleeve relative to the container shell determines a first dispersion rate; and
dispersing the materials by rotating the container.

10. The method of claim 9, wherein the sleeve is moved by means of a sleeve adjustment mechanism.

11. The method of claim 10, wherein the sleeve adjustment mechanism comprises a linear actuator.

12. The method of claim 9, further comprising the step of moving the sleeve to a second position relative to the container shell, wherein the second position of the sleeve relative to the container shell determines a second dispersion rate.
